(19) United States
(12) Patent Application Publication
(10) Pub. No.: US 2026/0097458 A1
(43) Pub. Date: Apr. 9, 2026

(54) HYDRAULIC CENTRE PINTLE PULLER

(71) Applicant: CANADIAN NATURAL UPGRADING LIMITED, Calgary (CA)

(72) Inventors: Jason WELLER, Fort McMurray (CA); Jeff SCHILLER, Spruce Grove (CA); Vaibhav PANDEY, Calgary (CA); Andrew MACKOWSKI, Sarnia (CA); Michael EZEKIEL, Vernon (CA)

(21) Appl. No.: 19/112,745

(22) PCT Filed: Sep. 20, 2023
(86) PCT No.: PCT/CA2023/051245

§ 371 Date: Mar. 18, 2025

Related U.S. Application Data
(60) Provisional application No. 63/376,468, filed on Sep. 21, 2022.

(51) Int. Cl. B23P 6/00; E02F 9/12

(52) U.S. Cl. CPC B23P 6/00; E02F 9/121

(57) ABSTRACT

Disclosed are a method and apparatus for removing a centre pintle from the bore of a machine. The apparatus comprises a pulling assembly and an elongate freezer assembly insert sized for insertion into the centre pintle bore, to form a space between the freezer assembly insert and the wall of the centre pintle bore. The space holds liquid nitrogen to contract the pintle enough to release the interference fit between the pintle and the machine bore, so that the pintle can be pulled out of the bore. The apparatus and method conserve liquid nitrogen, reduce machine down time and are safer than known methods for removal of a centre pintle.

### CROSS-REFERENCE TO RELATED APPLICATIONS

This application claims the benefit under 35 U.S.C 119 (e) of U.S. Provisional application No. 63/376,468, filed on Sep. 21, 2022, incorporated herein by reference in its entirety.

### FIELD

This disclosure relates to an apparatus and method for removing the centre pintle from a large-capacity machine, such as an electric rope shovel.

### BACKGROUND

Large-capacity machines are used as primary production equipment in many surface mining operations, such as oil sands mining. Rope shovels are such a machine. These shovels have a lower, upper, and front-end assembly. FIG. 1 labelled “Prior Art” illustrates an exemplary rope shovel. The lower assembly, also known as the carbody or “base” (A, FIG. 1), comprises the propel drive and crawler systems of the machine, which help it to propel, reposition, and relocate during its operation and provides a solid and stable base for the upper and front-end assemblies. The upper assembly, or “frame” (B, FIG. 1), is supported on the base by a swing mechanism that facilitates pivoting of the frame about a substantially vertical axis when coupled to the base. The frame consists of multiple decks with housing for the hoist and swing machinery and electronic control cabinet on the lower deck and the operator's cab on the upper deck. The front-end assembly (C, FIG. 1), comprises the boom, crowd machinery, dipper handle, dipper, and ropes, and pivots with the frame.

The swing mechanism may include a pintle assembly for pivotally coupling the frame and base. The pintle assembly is disposed between the frame and base and includes a hub in the lower assembly (base) and a shaft (centre pintle) in the upper assembly (frame) that are typically aligned along a central axis D, as shown in FIG. 1. The centre pintle hub is fixed to the base and is structured to support and accommodate a lower end of the centre pintle. An upper end of the centre pintle is fixed to the upper assembly (frame). During operation, the swing mechanism rotates the frame and shaft (centre pintle), within the lower assembly (base).

Electric rope shovels require regular maintenance, including the preventative change out of a part or parts that fail on a regular basis. One of the parts that needs to be replaced is the centre pintle. There are no tools designed specifically to remove the centre pintle, an operation that can take up to 72 hours to complete. The procedure can be dangerous as it requires the maintenance crew to be in the line of fire while lancing and shimming the pintle to loosen it, and it exposes them to contact with liquid nitrogen.

The centre pintle is fit by an interference fit inside a bore of the frame, using precise tolerances. The centre pintle is hollow, and for removal it is filled with liquid nitrogen to shrink the metal, releasing the interference fit. It is then pulled out of the bore and a new cold pintle inserted. Once the metal returns to normal temperature, the centre pintle will be locktight in the frame of the machine.

It would be desirable to have an apparatus and method that reduces the downtime for the maintenance of centre pintles from the current 72 hours, that is less costly than current methods, and that is safer for workers.

### SUMMARY

In one aspect described herein is an apparatus for removing a centre pintle from the bore of a machine, the centre pintle having a centre pintle bore having a wall, the apparatus comprising:
a pulling assembly for pulling the centre pintle out of the bore of the machine;
an elongate freezer assembly insert sized for insertion into the centre pintle bore to form an annular space between the freezer assembly insert and the wall of the centre pintle bore, the freezer assembly insert being configured for connection to the centre pintle;
the annular space having a top end and a bottom end, the bottom end being sealed to prevent water leakage therethrough and the top end being configured for introduction of water or liquid nitrogen into the annular space; and
a connector connected to the pulling assembly and to the freezer assembly insert, such that a pulling force by the pulling assembly on the connector will pull the freezer assembly insert, and thereby the centre pintle when connected to the freezer assembly insert, out of the bore of the machine.

In one embodiment the freezer assembly insert further comprises an insulator that thermally insulates the connector from liquid nitrogen introduced into the annular space.

In one embodiment the freezer assembly insert further comprises an elongate central bore and a wall around the elongate central bore. In one embodiment the connector is an elongate extension rod inserted into the elongate central bore.

In one embodiment the wall is an insulating wall that thermally insulates the connector from liquid nitrogen introduced into the annular space. In one embodiment the insulating wall is an enclosed air space.

In one embodiment the pulling assembly comprises a hydraulic cylinder or an electric rod actuator.

In one embodiment the apparatus further comprises a spacer assembly to support the apparatus above and in axial alignment with the centre pintle.

In another aspect, disclosed herein is a method of removing a centre pintle from the bore of a machine, the method comprising:
inserting a freezer assembly insert into a central bore of the centre pintle so as to form an annular space between an outer wall of the freezer assembly insert and a wall of the central bore, the annular space having a sealed bottom;
connecting the freezer assembly insert to the centre pintle;
dispensing water into the annular space;
dispensing liquid nitrogen into the annular space after the water is dispensed;
allowing the liquid nitrogen to contact the wall of the central bore of the pintle until the centre pintle contracts enough to release an interference fit between the centre pintle and the bore of the machine; and
after the centre pintle contracts, pulling upwards on the freezer assembly insert, to pull the centre pintle out of the bore of the machine.

In one embodiment, pulling upwards on the freezer assembly insert comprises pulling upwards on a connector connected to the freezer assembly insert.

In one embodiment the method further comprises the step of thermally insulating the connector from the liquid nitrogen dispensed into the annular space.

In one embodiment the step of connecting the freezer assembly insert to the centre pintle comprises disposing a puller ring under a bottom end of the centre pintle and connecting the puller ring to the freezer assembly insert.

In one embodiment the method further comprises the step of pulling upwards on the freezer assembly insert by actuating a hydraulic cylinder or an electric rod actuator.

### BRIEF DESCRIPTION OF THE DRAWINGS

FIG. 1—“Prior Art”—shows a side view of an exemplary rope shovel.

FIG. 2 is an exploded view of an embodiment of the parts of the centre pintle puller apparatus disclosed herein.

FIG. 3 shows the parts of the embodiment of FIG. 2 assembled together on top of the frame of a rope shovel.

FIG. 4A shows detail of the means for connecting the pulling assembly to the spacer assembly.

FIG. 4B shows details of the leveling means.

FIG. 5 is a cross section of the bottom of the extension rod connector and freezer assembly insert inserted into and secured to the centre pintle.

FIG. 6 shows the detail of the connection between the hydraulic cylinder piston rod and the extension rod connector.

FIG. 7 is a cross section of the top of the extension rod connector and freezer assembly insert inserted into the centre pintle.

FIG. 8 is a cross-section of the top of the extension rod connector and freezer assembly insert inserted into the centre pintle, after the pintle has been pulled out of the bore of the machine and secured to the spacer assembly.

FIG. 9 shows the detail of top of the extension rod connector with a lifting eye attached thereto, inserted into the freezer assembly insert.

FIG. 10 shows a detailed view of the components used to connect the bottom of the extension rod connector and freezer assembly insert to the bottom of the centre pintle.

FIG. 11 shows the top of centre pintle after removal from the bore of the machine and after removal of the freezer assembly insert, while still secured to the spacer assembly with keepers.

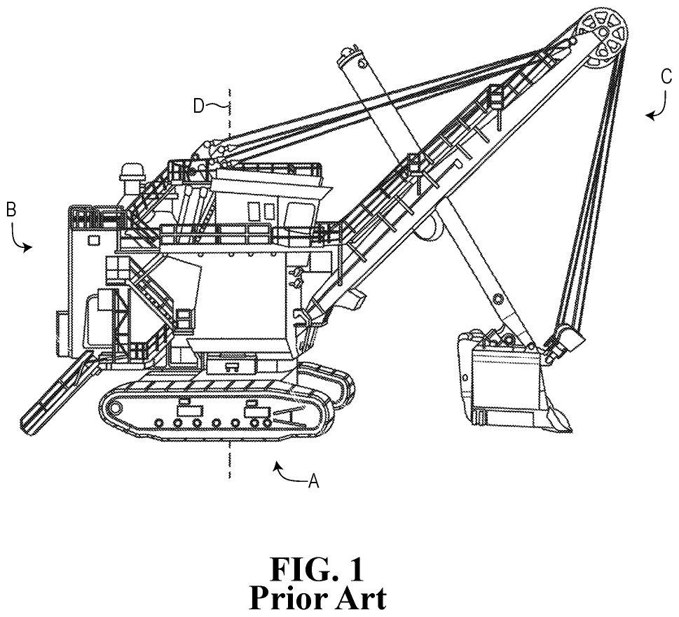

### DETAILED DESCRIPTION

Disclosed herein is an apparatus and method for removing the centre pintle from a machine, which reduce the hazards associated with removing the centre pintle, as compared to known apparatus and processes. The apparatus and/or method reduce the downtime for the maintenance of centre pintles from 72 hours to about 12 hours, use significantly less liquid nitrogen than prior methods, and are safer for workers as they are removed from the line of fire and have reduced risk of exposure to liquid nitrogen. Efficiency is therefore improved.

The centre pintle puller comprises a puller assembly, for example a hydraulic cylinder, or electric rod actuator, that is capable of pulling the centre pintle out of machinery, for example, rope shovels (e.g., a 7495 electric cable shovel). With this apparatus, centre pintle removal takes about 12 hours, as lancing/shimming are no longer required, resulting in a downtime reduction of about 83%.

Also, by eliminating the need for shimming/lancing, the use of liquid nitrogen can be reduced from a full tanker truck (e.g., approx. 2,000 gallons or more) to only a few tanks (e.g., about 135 gallons), which is a cost savings of up to 92%.

The centre pintle puller is assembled in the field and installed on the frame of the shovel or other machine, for centre pintle removal. In an embodiment a hydraulic cylinder is extended to the bottom of the centre pintle, and a capture plate is installed on the bottom. A freezer assembly insert is inserted into the centre pintle bore, after which liquid nitrogen (or another suitable fluid cryogenic agent) is introduced into the centre pintle bore, to contract the pintle. The cylinder is hydraulically retracted, removing the centre pintle from the upper and lower works of the shovel or other machine.

The puller apparatus disclosed herein comprises a puller assembly 1 to pull the centre pintle out of the machine, a connector 6 for connecting the puller assembly to the centre pintle and/or freezer assembly insert, and a freezer assembly insert 9 for insertion into the centre pintle bore. The assembled puller is placed on top of a spacer assembly 2, which positions the puller apparatus above and in axial alignment with the centre pintle and spaces the puller apparatus a distance from the machine, so that the centre pintle can be pulled clear out of the machine. “Connected to” or “attached to” when used herein may refer to a direct or indirect connection or attachment.

The puller assembly 1 provides the pulling force required to pull the centre pintle out of the bore of the machine. The connector 6 reversibly connects the centre pintle to the puller assembly 1, so that a pulling force applied by the puller assembly 1 will pull the centre pintle out of the machine. The freezer assembly insert 9 takes up at least some of the volume of the centre pintle bore, thereby reducing the amount of liquid nitrogen that can fit into the centre pintle bore at one time, as compared to a bore without insert 9 therein. Finally, the spacer assembly 2 spaces the puller assembly above the machine and in line with the pintle, so that when the puller assembly is actuated, there is sufficient linear distance for the pintle to be pulled out of the bore of the machine.

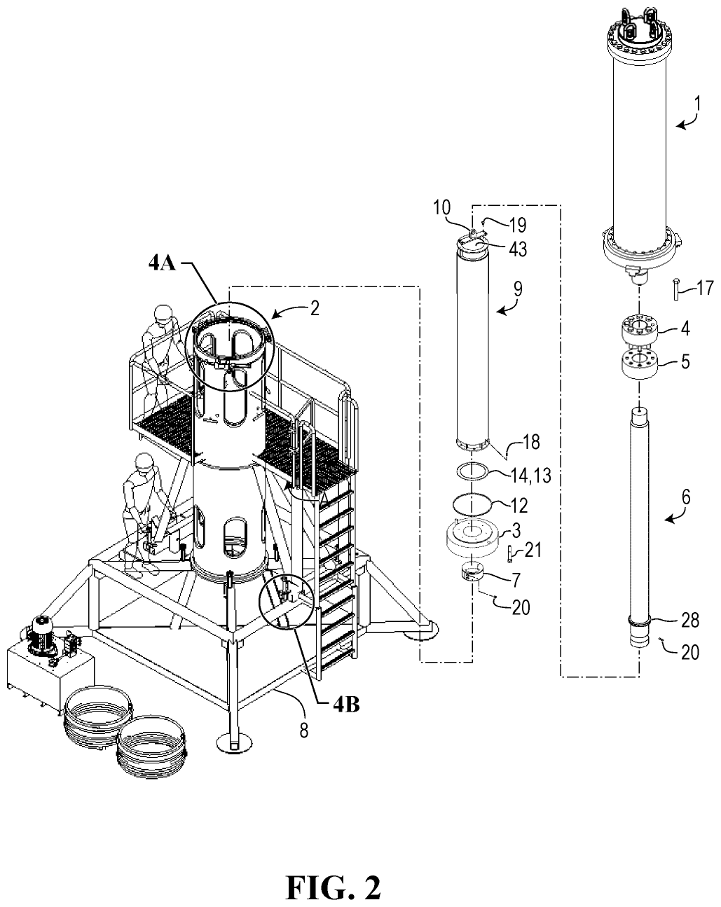

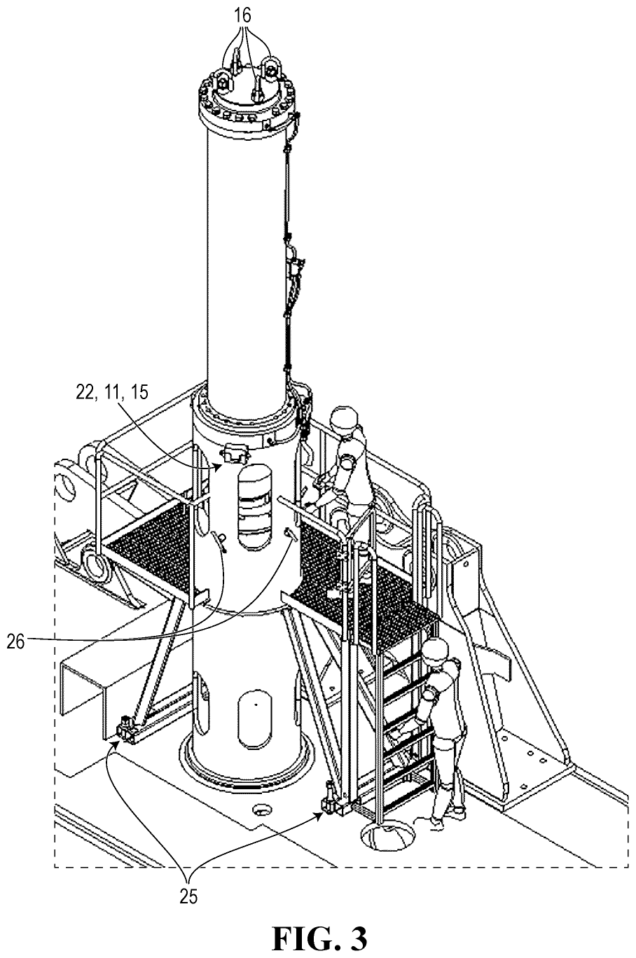

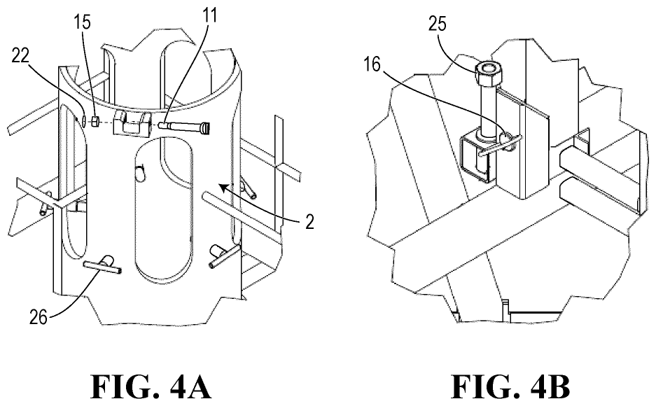

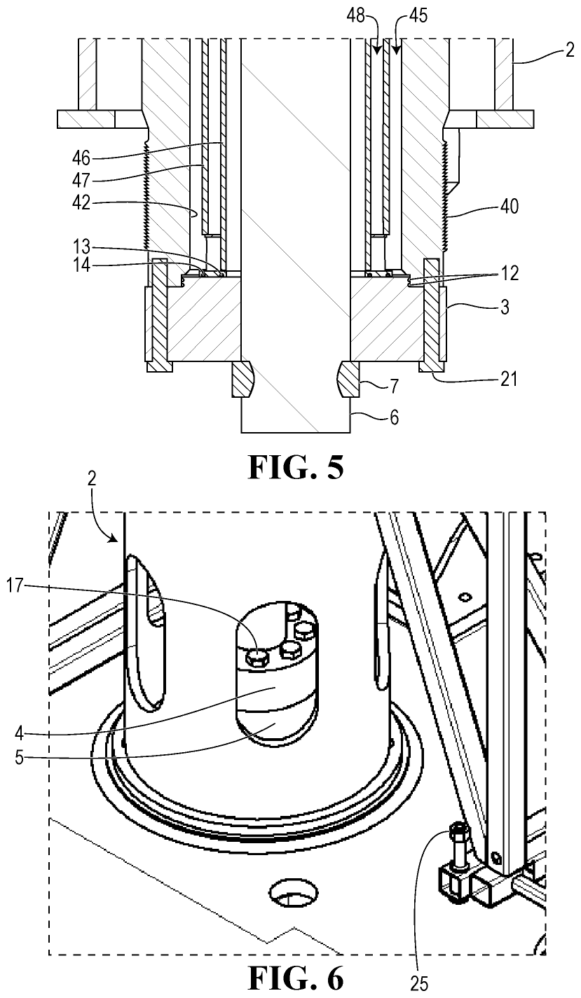

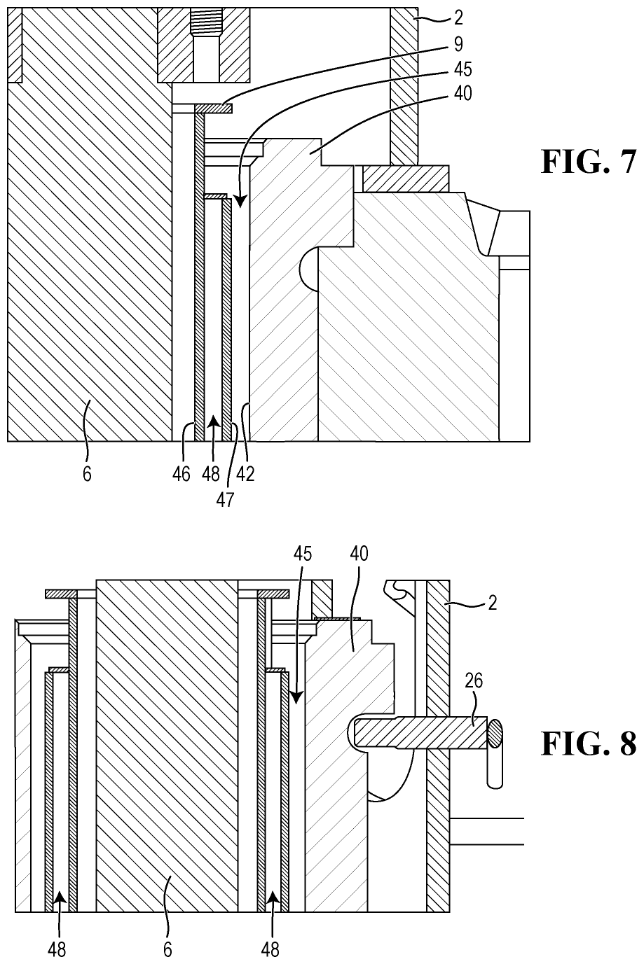

A preferred embodiment of the centre pintle puller disclosed herein comprises: a puller assembly 1 that is a hydraulic cylinder assembly, an elongate extension rod connector 6, an elongate freezer assembly insert 9 and a spacer assembly 2 that is a tube weldment 2—see FIG. 2. In this preferred embodiment the elongate extension rod connector 6 is sized to fit inside an elongate bore 43 of the freezer assembly insert 9. The freezer assembly insert 9 is sized to fit inside the central bore 41 of the centre pintle 40 (FIG. 11), leaving an annular space 45 between an outer wall 44 of the freezer assembly insert and the wall 42 of the centre pintle bore 41 (FIG. 5). The hydraulic cylinder assembly 1 is sized for mounting onto the spacer tube weldment 2, such that it is spaced from the top of the machine and over and in axial alignment with the centre pintle-see FIG. 3.

In this embodiment the hydraulic cylinder assembly 1, connects to and pulls on the extension rod connector 6, thereby pulling the centre pintle out of the bore of the frame of the machine and into the spacer assembly 2, as described below.

In this embodiment the freezer assembly insert 9 comprises a bore to accommodate insertion of the extension rod connector 6 therethrough. The freezer assembly insert is configured so that a volume of liquid nitrogen may be held in the annular space 45 in proximity to the centre pintle, such that the pintle is cooled by the liquid nitrogen until it shrinks enough to enable removal from the frame. In an embodiment, the freezer assembly insert 9 is an elongate cylindrical tube comprising a bore 43 and wall 44 thereabout. In an embodiment the wall 44 comprises an inner wall 46 and an outer wall 47 with an air space 48 between the two walls. The wall 44, is sized to form an annular space 45 between the outside of the wall 44 and the centre pintle bore wall 42, such that a volume, or successive volumes, of liquid nitrogen can be disposed in the annular space to cool the pintle for removal. The wall 44 is sized to provide an inner bore 43 for insertion of the elongate extension rod 6 therethrough. In embodiments having a wall 44 that is double walled, the air space between the outer wall 47 and inner wall 46 may function to thermally insulate, at least in part, the extension rod 6 from the from the liquid nitrogen and reduce the cooling of this rod as compared to the cooling of the pintle.

In this embodiment the extension rod connector 6 connects with the cylinder rod and the centre pintle 40 (indirectly via puller ring 3) such that a pulling force exerted on the extension rod 6 by the cylinder rod will pull the centre pintle 40 out of the base and frame of the machine, after the pintle has been contracted by cooling with liquid nitrogen.

In embodiments, the top end of the extension rod connector 6 is connected to the cylinder rod, for example using coupler plates 4,5 (FIG. 6).

In embodiments the bottom end of the extension rod connector 6 has a circumferential groove to accommodate a shear collar 7 (FIG. 5). Shear collar 7 is positioned underneath puller ring 3 which is in turn positioned under the bottom end of the centre pintle 40, so that an upwards pulling force on the extension rod connector 6 pulls the centre pintle upwards and out of the bore of the frame-see FIG. 5. In the embodiments shown herein, puller ring 3 is connected to the bottom of the freezer assembly insert 6, and to the bottom of the centre pintle. Therefore, the upward pulling force on the extension rod connector 6 pulls both the centre pintle 40 and the freezer assembly insert 9 upwards.

O-rings 12, 13 and 14 seal the connection between the freezer assembly insert and centre pintle, so that a quantity of water introduced to the bottom of annular space 45 does not flow out of this space. This water will seal the bottom of the annular space to liquid nitrogen, by freezing after the liquid nitrogen is introduced into this space.

While depicted herein as a hydraulic cylinder, any type of device or equipment that can provide the pulling force required to pull the centre pintle out of the bore of the machine, after the pintle is sufficiently contracted by the liquid nitrogen, is contemplated herein for the puller assembly 1. For example, an electric rod actuator may be used instead of a hydraulic cylinder.

While depicted herein as being an elongate cylinder having a constant exterior diameter and a constant bore diameter, the freezer assembly insert 9 may have exterior or bore diameters that change along its length. Likewise, the thickness of air space 48 may vary along the length of the insert.

The embodiment of the freezer assembly insert 9 is shown as having two walls with an airspace between the walls to thermally insulate, at least in part, the extension rod from the liquid nitrogen and reduce cooling of this rod. Other means of insulating may be used, for example, a material other than air between the double wall, a vacuum between the double wall, or a wall made of an insulating material.

While depicted herein as being two separate components, the extension rod connector 6 and freezer assembly insert 9 may be a unitary construct.

Also disclosed is a method of removing a centre pintle from the bore of a machine. The method comprises the steps of:
inserting a freezer assembly insert into the bore of the centre pintle so as to form an annular space between the outer wall of the freezer assembly insert and the wall of the bore, the annular space being sealed at a bottom. In a preferred embodiment the freezer assembly insert is an elongate structure that forms an elongate annular space between the freezer insert and the wall of the bore of the centre pintle;
connecting the freezer assembly insert to the centre pintle. In a preferred embodiment the freezer assembly insert is secured at its bottom, to the bottom of the centre pintle, such that the annular space extends to the bottom of the centre pintle;
dispensing water into the bottom of the annular space. The amount of water dispensed is sufficient to freeze at the bottom of the annular space when liquid nitrogen is added, thereby preventing liquid nitrogen from leaking from the annular space;
dispensing liquid nitrogen into the annular space above the water;
allowing the liquid nitrogen to contact the wall of the bore of the centre pintle until the centre pintle shrinks (contracts) enough to release the interference fit between the pintle and the bore of the machine. Liquid nitrogen may be added into the annular space in several aliquots in order to achieve sufficient shrinkage (contraction) to allow removal of the centre pintle;
after the centre pintle shrinks (contracts), pulling upwards on the freezer assembly insert to pull the centre pintle out of the frame. In embodiments the freezer assembly insert comprises a bore to accommodate an extension rod and the step of pulling upwards on the freezer assembly insert comprises pulling upwards on the extension rod, thereby pulling upwards on the freezer assembly insert and the centre pintle.

Having described the main components of the centre pintle puller, and a method for use, an exemplary embodiment of the use of this puller to remove a centre pintle from a rope shovel will now be described in detail having reference to the Figures.

### Cylinder Preparation & Operation & De-Energizing

A cylinder stand 8 is placed on a level and graded site location. The stand will be used for assembly and disassembly of the puller when it is removed from the shovel.

The cylinder uses two counterbalance valves to hold the load in the event that a hydraulic hose or fitting ruptures and pressure is lost to the cylinder. The chart below shows the relationship between the load induced pressure and the pump pressure of the power pack. The gauge pressure at the pump reads 600-1200 psi when the cylinder is cycled under no load.

| Load induced | Retract Pressure | Retract |
|---|---|---|
| Pressure (psi) | at Pump (psi) | Load (tons) |
| 0 | 667 | 0 |
| 400 | 977 | 50 |
| 800 | 1289 | 100 |
| 1200 | 1600 | 150 |
| 1600 | 1911 | 200 |
| 2000 | 2222 | 250 |
| 2400 | 2533 | 300 |
| 2800 | 2844 | 350 |
| 3200 | 3200 | 400 |
| 3600 | 3600 | 450 |

### General Preparation for Removal of Centre Pintle

Upper and lower coupler plates 4 & 5 (FIG. 2) are threaded onto the cylinder rod of the cylinder assembly 1 and extension rod 6, respectively. The couplers are threaded until they are fully seated against the shoulders of the rods. A low strength locking compound, e.g., Loctite ThreadLocker Blue 242™, may be used on the last 2-3 threads.

A lift fixture 10 is attached to the freezer assembly insert 9 using capscrews 19. Puller ring 3 is positioned below the truck frame, in line with the centre pintle. Pedestal jack bolts 25, clevis pin 16 and keepers 11 and 26 are made ready.

A split collar 28 is installed onto extension rod 6 using cap screws 20 and torqued to fit (e.g., 49 ft-lb or 66 Nm). Collar 28 acts as a locating shoulder when lowering the extension rod 6 through the puller ring 3, to prevent the rod from falling through the puller ring.

### Removal of Centre Pintle

Cylinder assembly 1 is connected to the top of spacer tube 2 and secured with keepers 11, nuts 15 and cotter pins 22 (FIG. 3, 4A). The freezer assembly insert 9 is hoisted into position and puller ring 3 is attached to the freezer assembly insert, O-rings 13, 14 and cap screws 18 are installed and torqued to 49 ft-lb (66 Nm).

The freezer assembly insert 9 is raised to attach the puller ring 3 to the centre pintle with cap screws 21 and O-rings 12. The lift fixture 10 is removed. The extension rod 6 is lowered through the freezer assembly insert 9 and a shear collar 7 is attached to the rod 6 with cap crews 20 that are torqued to 250 ft-lb (338 Nm).

The assembled cylinder 1 and spacer tube 2 are lifted into position on the revolving (upper frame) of the shovel (FIG. 3). A preferred orientation of the work platform is shown in this figure. The assembly is leveled with pedestal jackbolts 25. Air is bled from the hydraulic system and hydraulic lines from the hydraulic power pack are attached to the cylinder.

The cylinder rod is cycled 3 to 5 times, under no load, while monitoring the hydraulic fluid level in the reservoir of the power pack. The power pack's pressure gauge may read 600-1200 psi while cycling the cylinder rod under no load, due to the counterbalance valves load holding settings.

Coupler bolts 17 are installed in upper and lower coupler plates 4 & 5 and torqued to 250 ft-lbs (338 Nm). A low torque is used to give more tensile strength to cap screws. 1-3 gallons of water is poured into the annular space 45 between the pintle and the freezer. The water acts as an ice dam to seal the liquid nitrogen and protect the O-ring seals. The assembly is checked to ensure that there is no leakage of water.

The annular space 45 (“cavity”) between the freezer and pintle is filled with liquid nitrogen. After a suitable soak time, the hydraulic cylinder is activated to remove the centre pintle. The centre pintle is held in the bore of the frame of the machine by an interference (shrink) fit. Thermal contraction is used to remove the centre pintle from the bore of the frame. A suitable soak time is an amount of time that results in sufficient shrinkage of the centre pintle such that it can be removed from the bore of the frame. More liquid nitrogen may need to be added to the annulus space to achieve this shrinkage.

Once the pintle has cleared the bore of the frame, the pintle is secured using keepers 26. The keepers are tightened by hand until full contact is made. Note, the keepers are designed to slide under the pintle shoulder and lock the pintle in place using an undercut radius (shown in FIG. 8)

The hydraulic lines are disconnected from the cylinder. Rigging is attached to the cylinder to hoist the assembly off of the frame.

### Pintle Dissemble Procedure

The cylinder and spacer tube are placed on the cylinder stand 8 and secured with pins 16 and cotter pins. Puller ring 3 is cribbed, maintaining access to bolts.

The coupler bolts 17 are removed, and a crane/hoist are attached to the cylinder hoist rings. The cylinder assembly is disassembled from the spacer tube by removing keepers 11, nuts 15 and cotter pins 22. The cylinder is hoisted to a suitable location.

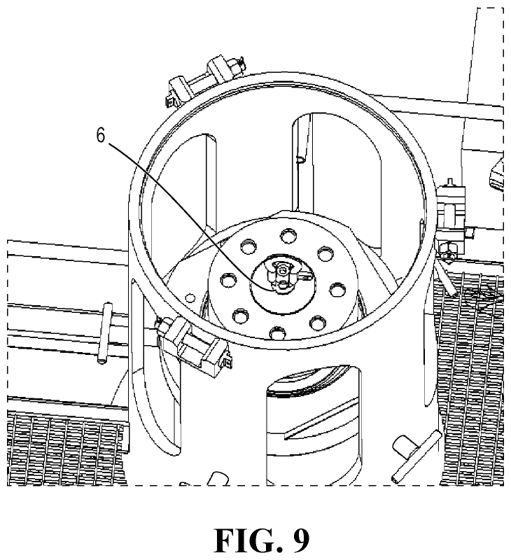

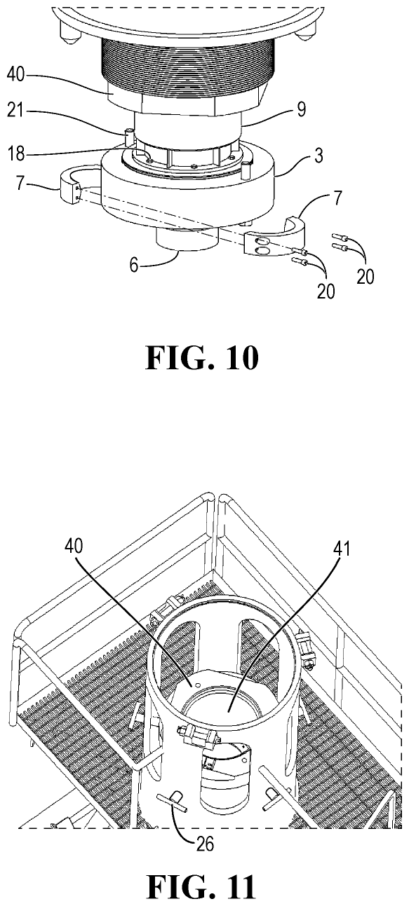

A lifting eye is attached to extension rod 6 (see FIG. 9) and attached to a crane/hoist. The collar 7 is removed from the extension rod 6 and the extension rod 6 is hoisted to suitable location. The lift fixture 10 is attached to freezer assembly insert 9 using cap screws 19 which are torqued up to 140 in-lbs (15.8 Nm).

If there is residual liquid nitrogen in annulus 45, it is allowed to evaporate A hoist is attached to the lift fixture 10 and tensioned, and bolts 21 are removed from puller ring 3. Cribbing is removed, puller ring 3 is lowered to the platform and capscrews 18 removed. The freezer assembly insert is hoisted from the spacer assembly.

The centre pintle is now ready to be removed. A lifting jig & hoist are attached to the centre pintle, and the hoist is tensioned until the keepers 26 turn freely by hand. The keepers 26 are unthreaded until the pintle can be removed.

While the apparatus and method have been described in conjunction with use to remove a center pintle from a rope shovel, it will be appreciated that the method and apparatus can be used on other machines that have a center pintle.

While the apparatus and method have been described in conjunction with the disclosed embodiments which are set forth in detail, it should be understood that this is by illustration only and the disclosure is not intended to be limited to these embodiments. On the contrary, this disclosure is intended to cover alternatives, modifications, and equivalents which will become apparent to those skilled in the art in view of this disclosure.

1. An apparatus for removing a centre pintle from the bore of a machine, the centre pintle having a centre pintle bore having a wall, the apparatus comprising:
a) a pulling assembly for pulling the centre pintle out of the bore of the machine;
b) an elongate freezer assembly insert sized for insertion into the centre pintle bore to form an annular space between the freezer assembly insert and the wall of the centre pintle bore, the freezer assembly insert being configured for connection to the centre pintle;
c) the annular space having a top end and a bottom end, the bottom end sealed to prevent water leakage therethrough and the top end configured for introduction of water or liquid nitrogen into the annular space; and
d) a connector connected to the pulling assembly and to the freezer assembly insert, such that a pulling force by the pulling assembly on the connector will pull the freezer assembly insert, and thereby the centre pintle when connected to the freezer assembly insert, out of the bore of the machine.

2. The apparatus of claim 1 wherein the freezer assembly insert further comprises an insulator that thermally insulates the connector from liquid nitrogen introduced into the annular space.

3. The apparatus of claim 1 wherein the freezer assembly insert further comprises an elongate central bore and a wall around the elongate central bore.

4. The apparatus of claim 3 where the connector is an elongate extension rod inserted into the elongate central bore.

5. The apparatus of claim 3, wherein the wall is an insulating wall that thermally insulates the connector from liquid nitrogen introduced into the annular space.

6. The apparatus of claim 5 wherein the insulating wall comprises an enclosed air space.

7. The apparatus of claim 1, wherein the pulling assembly comprises a hydraulic cylinder or an electric rod actuator.

8. The apparatus of claim 1 further comprising a spacer assembly to support the apparatus above and in axial alignment with the centre pintle.

9. A method of removing a centre pintle from the bore of a machine comprising:
a) inserting a freezer assembly insert into a central bore of the centre pintle so as to form an annular space between an outer wall of the freezer assembly insert and a wall of the central bore, the annular space having a sealed bottom;
b) connecting the freezer assembly insert to the centre pintle;
c) dispensing water into the annular space;
d) dispensing liquid nitrogen into the annular space after the water is dispensed;
e) allowing the liquid nitrogen to contact the wall of the central bore of the pintle until the centre pintle contracts enough to release an interference fit between the centre pintle and the bore of the machine; and
f) after the centre pintle contracts, pulling upwards on the freezer assembly insert, to pull the centre pintle out of the bore of the machine.

10. The method of claim 9, wherein pulling upwards on the freezer assembly insert comprises pulling upwards on a connector connected to the freezer assembly insert.

11. The method of claim 10 further comprising the step of thermally insulating the connector from the liquid nitrogen dispensed into the annular space.

12. The method of claim 9 wherein the step of connecting the freezer assembly insert to the centre pintle comprises disposing a puller ring under a bottom end of the centre pintle and connecting the puller ring to the freezer assembly insert.

13. The method of claim 9, wherein the step of pulling upwards on the freezer assembly insert is performed by actuating a hydraulic cylinder or an electric rod actuator.
